(19) United States
(12) Patent Application Publication
(10) Pub. No.: US 2019/0313382 A1
(43) Pub. Date: Oct. 10, 2019

(54) Control Data for Code Block Group-Based Retransmission

(71) Applicant: Apple Inc., Cupertino, CA (US)

(72) Inventors: Haitong Sun, Irvine, CA (US); Yuchul Kim, Santa Clara, CA (US); Johnson O. Sebeni, Fremont, CA (US); Wei Zeng, San Diego, CA (US); Wei Zhang, Santa Clara, CA (US); Dawei Zhang, Saratoga, CA (US)

(21) Appl. No.: 16/371,465

(22) Filed: Apr. 1, 2019

Related U.S. Application Data
(60) Provisional application No. 62/652,431, filed on Apr. 4, 2018.

(51) Int. Cl. H04W 72/04; H04L 1/18

(52) U.S. Cl. CPC H04W 72/042; H04L 1/1893; H04L 1/1819

(57) ABSTRACT

Techniques are disclosed relating to control data for retransmissions in wireless communications. In various embodiments, a UE sends acknowledgements (e.g., HARQ acknowledgements) at code block group (CBG) granularity. CBGs may be included in codewords that may be transmitted using multiple MIMO layers. In some embodiments, the network is configured to send a new data indicator for each CBG. In some embodiments, the network is configured to use a different number of layers for a retransmission of a CBG than for the original transmission. Thus, the layer-to-CBG or layer-to-codeword mapping may be specified dynamically. In various embodiments, the disclosed techniques may improve overall network bandwidth relative to traditional retransmission techniques.

### PRIORITY CLAIM

This application claims the benefit of U.S. Provisional Application No. 62/652,431, filed on Apr. 4, 2018, which is incorporated by reference herein in its entirety.

### FIELD

The present application relates to wireless communications, and more particularly to control data for retransmissions.

### DESCRIPTION OF THE RELATED ART

Wireless communication systems are rapidly growing in usage. Additionally, there exist numerous different wireless communication technologies and standards. Some examples of wireless communication technologies include GSM, UMTS (associated with, for example, WCDMA or TD-SCDMA air interfaces), LTE, LTE Advanced (LTE-A), HSPA, 3GPP2 CDMA2000 (e.g., 1xRTT, 1xEV-DO, HRPD, eHRPD), IEEE 802.11 (WLAN or Wi-Fi), IEEE 802.16 (WiMAX), Bluetooth, and others.

For some wireless communications standards, such as the 5G air interface physical layer design for example, various different types of services are being proposed. For example, an enhanced mobile broadband (eMBB) service may provide high-rate data service with a latency requirement (e.g., 4 ms) and an ultra reliable low latency (URLLC) service may provide highly reliable service with a lower latency requirement (e.g., 0.5 ms) than eMBB. Speaking generally, different services that use a unified physical layer framework may have very different natures in terms of reliability, latency, data rate, etc. Accommodating such different services while maintaining performance, low complexity, and low power consumption (e.g., both at the base station and mobile devices) may be challenging.

### BRIEF DESCRIPTION OF THE DRAWINGS

A better understanding of the present subject matter can be obtained when the following detailed description of the embodiments is considered in conjunction with the following drawings, in which:

FIG. 1 illustrates an exemplary (and simplified) wireless communication system, according to some embodiments.

FIG. 2 illustrates a base station (BS) in communication with a user equipment (UE) device, according to some embodiments.

FIG. 3 illustrates an exemplary block diagram of a UE, according to some embodiments.

FIG. 4 illustrates an exemplary block diagram of a BS, according to some embodiments.

FIG. 5A is a diagram illustrating multiple codewords that each include multiple CBGs and are each transmitted using multiple MIMO layers, according to some embodiments.

FIG. 5B is a diagram illustrating exemplary retransmissions for the example of FIG. 5A, according to some embodiments.

FIG. 6 is a diagram illustrating exemplary retransmissions with a per-CBG new data indicator, according to some embodiments.

FIG. 7A is a diagram illustrating exemplary retransmissions with dynamic mapping of layers to codewords and/or CBGs, according to some embodiments.

FIG. 7B is a diagram illustrating exemplary codeword-to-layer and CBG-to-layer mappings.

FIG. 8 is a diagram illustrating another example of retransmissions with dynamic mapping of layers to codewords and/or CBGs, according to some embodiments.

FIG. 9 is a flow diagram illustrating an example method for using new data indicators at CBG granularity, according to some embodiments.

FIG. 10 is a flow diagram illustrating an example method for adjusting MIMO layers for retransmissions, according to some embodiments.

FIG. 11 is a diagram illustrating an example memory medium and fabrication system, according to some embodiments.

This specification includes references to various embodiments, to indicate that the present disclosure is not intended to refer to one particular implementation, but rather a range of embodiments that fall within the spirit of the present disclosure, including the appended claims. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “clock circuit configured to generate an output clock signal” is intended to cover, for example, a circuit that performs this function during operation, even if the circuit in question is not currently being used (e.g., power is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function. After appropriate programming, the FPGA may then be configured to perform that function.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

### DETAILED DESCRIPTION

### Acronyms

The following acronyms may be used in the present disclosure.

3GPP: Third Generation Partnership Project

3GPP2: Third Generation Partnership Project 2

APN: Access Point Name

BLER: Block Error Rate (same as Packet Error Rate)

BER: Bit Error Rate

CRC: Cyclic Redundancy Check

DL: Downlink

GBR: Guaranteed Bit Rate

GSM: Global System for Mobile Communications

IMS: IP Multimedia Subsystem

IP: Internet Protocol

LTE: Long Term Evolution

MME: Mobility Management Entity

MO: Message Originating

MT: Message Terminating

NAS: Non-access Stratum

PCC: Policy and Charging Control

PCEF: Policy and Charging Enforcement Function

PCRF: Policy and Charging Rules Function

PCSCF: Proxy Call Session Control Function

PGW: Packet Gateway

PER: Packet Error Rate

QCI: Quality of Service Class Index

QoS: Quality of Service

RAT: Radio Access Technology

RRC: Radio Resource Control

SGW: Serving Gateway

SINR: Signal to Interference-and-Noise Ratio

SIR: Signal to Interference Ratio

SNR: Signal to Noise Ratio

Tx: Transmission

UE: User Equipment

UL: Uplink

UMTS: Universal Mobile Telecommunication System

VoLTE: Voice Over LTE

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., a smart watch, smart glasses), PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless cellular telephone system or cellular radio system.

Processing Element—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually,” where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

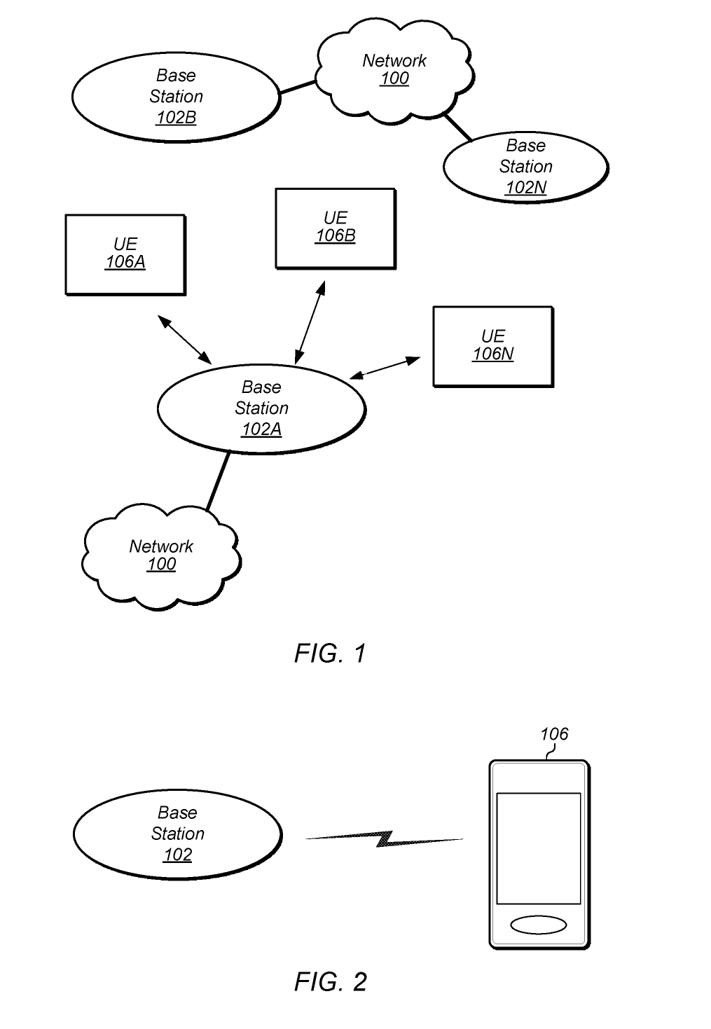

### FIGS. 1 and 2—Communication System

FIG. 1 illustrates an exemplary (and simplified) wireless communication system, according to some embodiments. It is noted that the system of FIG. 1 is merely one example of a possible system, and embodiments may be implemented in any of various systems, as desired.

As shown, the exemplary wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station 102A may be a base transceiver station (BTS) or cell site, and may include hardware that enables wireless communication with the UEs 106A-106N. The base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices (UEs) and/or between the UEs and the network 100.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (WCDMA, TD-SCDMA), LTE, LTE-Advanced (LTE-A), HSPA, 3GPP2 CDMA2000 (e.g., 1xRTT, 1xEV-DO, HRPD, eHRPD), Wi-Fi, WiMAX etc.

Base station 102A and other similar base stations (such as base stations 102B . . . 102N) operating according to the same or a different cellular communication standard may thus be provided as a network of cells, which may provide continuous or nearly continuous overlapping service to UEs 106A-160N and similar devices over a wide geographic area via one or more cellular communication standards.

Thus, while base station 102A may act as a “serving cell” for UEs 106A-160N as illustrated in FIG. 1, each UE 106 may also possibly come within communication range of, and be capable of receiving signals from, one or more other cells (which might be provided by base stations 102B-N and/or any other base stations), which may be referred to as “neighboring cells.” Such cells may also be capable of facilitating communication between user devices and/or between user devices and the network 100, according to the same wireless communication technology as base station 102A and/or any of various other possible wireless communication technologies. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

Note that a UE 106 may be capable of communicating using multiple wireless communication standards. For example, a UE 106 may be configured to communicate using a wireless networking (e.g., Wi-Fi) and/or peer-to-peer wireless communication protocol (e.g., BT, Wi-Fi peer-to-peer, etc.) in addition to at least one cellular communication protocol (e.g., GSM, UMTS (WCDMA, TD-SCDMA), LTE, LTE-A, HSPA, 3GPP2 CDMA2000 (e.g., 1xRTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

FIG. 2 illustrates user equipment 106 (e.g., one of the devices 106A-106N) in communication with a base station 102 (e.g., one of the base stations 102A-102N), according to some embodiments. The UE 106 may be a device with cellular communication capability such as a mobile phone, a hand-held device, a wearable device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein. Alternatively, or in addition, the UE 106 may include one or more integrated circuits configured to perform any of the method embodiments described herein.

The UE 106 may include one or more antennas for communicating using one or more wireless communication protocols or technologies. In some embodiments, the UE 106 is configured to communicate using either of CDMA2000 (1xRTT/1xEV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate (and possibly multiple) transmit and/or receive chains (e.g., including separate RF and/or digital radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 1xRTT (or LTE or GSM), and separate radios for communicating using each of Wi-Fi and Bluetooth. Other configurations are also possible.

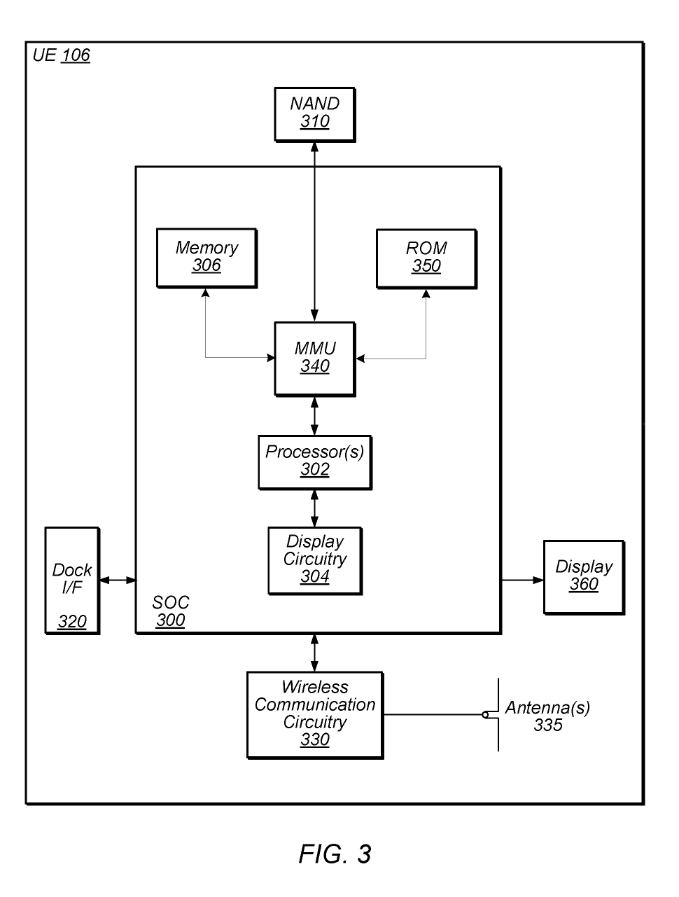

### FIG. 3—Exemplary Block Diagram of a UE

FIG. 3 illustrates an exemplary block diagram of a UE 106, according to some embodiments. As shown, the UE 106 may include a system on chip (SOC) 300, which may include processing elements for various purposes. For example, as shown, the SOC 300 may include processor(s) 302 which may execute program instructions for the UE 106 and display circuitry 304 which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, Wi-Fi, GPS, etc.).

The UE device 106 may include at least one antenna (and possibly multiple antennas, e.g., for MIMO and/or for implementing different wireless communication technologies, among various possibilities), for performing wireless communication with base stations and/or other devices. For example, the UE device 106 may use antenna(s) 335 to perform the wireless communication. As noted above, the UE 106 may be configured to communicate wirelessly using multiple wireless communication technologies in some embodiments.

As described further subsequently herein, the UE 106 may include hardware and software components for implementing features and methods described herein. The processor 302 of the UE device 106 may be configured to implement part or all of the methods described herein, e.g., by executing program instructions stored on a memory medium (e.g., a non-transitory computer-readable memory medium). In other embodiments, processor 302 may be configured as a programmable hardware element, such as an FPGA (Field Programmable Gate Array), or as an ASIC (Application Specific Integrated Circuit). Alternatively (or in addition), the processor 302 of the UE device 106, in conjunction with one or more of the other components 300, 304, 306, 310, 320, 330, 335, 340, 350, 360 may be configured to implement part or all of the features described herein.

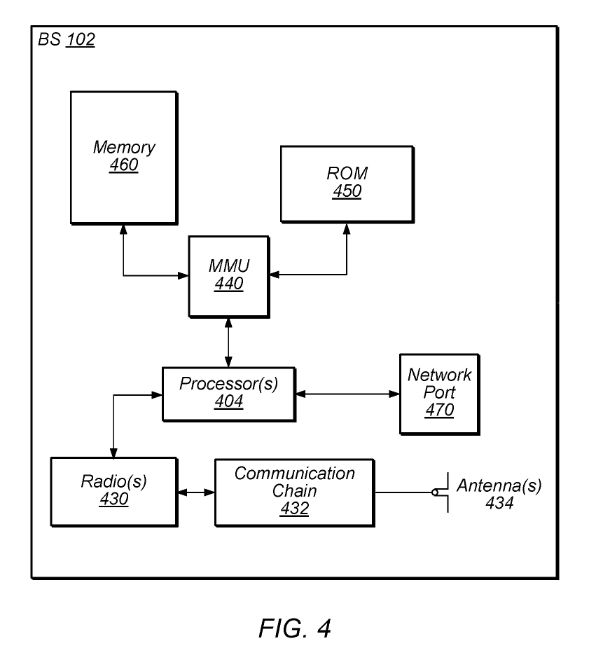

### FIG. 4—Exemplary Block Diagram of a Base Station

FIG. 4 illustrates an exemplary block diagram of a base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434, and possibly multiple antennas. The antenna(s) 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless telecommunication standards, including, but not limited to, LTE, LTE-A, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a Wi-Fi radio for performing communication according to Wi-Fi. In such a case, the base station 102 may be capable of operating as both an LTE base station and a Wi-Fi access point. As another possibility, the base station 102 may include a multi-mode radio which is capable of performing communications according to any of multiple wireless communication technologies (e.g., LTE and Wi-Fi).

The base station 102 may include hardware and software components for implementing or supporting implementation of features described herein. The processor 404 of the base station 102 may be configured to implement part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition), the processor 404 of the base station 102, in conjunction with one or more of the other components 430, 432, 434, 440, 450, 460, and/or 470, may be configured to implement or support implementation of part or all of the features described herein.

### Overview of Code Block Group (CBG)-Based Retransmission

In some embodiments, transport blocks of data to be transmitted that are greater than a threshold size are split into code blocks and code block groups. In these embodiments, a transport block includes one or more code block groups and a code block group (CBG) includes one or more code blocks. In some embodiments, the UE is configured to send separate HARQ acknowledgement signals for each code block group. For example, the UE may generate a bit for each CBG that indicates whether or not the CBG was successfully decoded. In some embodiments, this may allow the base station to retransmit less than the entirety of a transport block, e.g., by only retransmitting code block groups that failed. In these embodiments, acknowledgement signals may include a separate ACK bit for each CBG. Techniques for CBG-based acknowledgement are discussed, for example, in U.S. patent application Ser. No. 15/903,222, filed Feb. 23, 2018.

In some embodiments, multiple code block groups may be transmitted in a code word and a code word may be transmitted using multiple multiple-input multiple-output (MIMO) layers (note that layers may also be referred to as MIMO data streams). For example, in some implementations there may be a maximum of eight layers for downlink MIMO with a maximum of two codewords per transmission. In some implementations, for one to four layers there is one codeword per transmission and for five to eight layers there are two codewords per transmission (e.g., with the first N/2 layers for the first codeword and the remaining layers for the second codeword, where N is the number of layers and a floor operation when N is odd). In some implementations, a new data indicator (NDI) is specified at the codeword granularity. In some embodiments, techniques disclosed below provide additional throughput relative to the fixed mapping of layers to codewords and NDI granularity of the implementations discussed above.

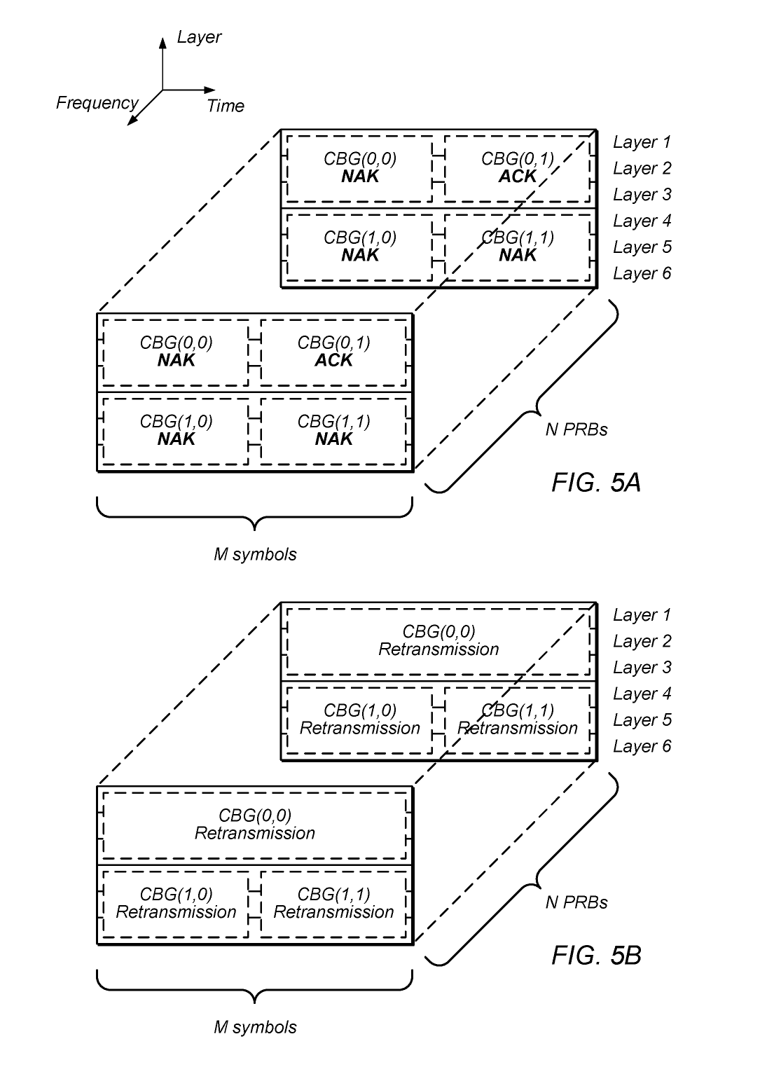

FIG. 5A is a diagram illustrating an exemplary transmission, according to some embodiments. In the illustrated embodiment, the transmission uses six layers and two codewords to carry data for four CBGs: CBG(0,0), CBG(0,1), CBG(1,0), and CBG(1,1). In the illustrated embodiment, the transmission uses M symbols in the time dimension and N physical resource blocks (PRBs) in the frequency dimension. In this example, the first codeword is transmitted using layers 1-3 includes CBGs (0,0) and (0,1) and the second codeword is transmitted using layers 4-6 and includes CBGs (1,0), and (1,1).

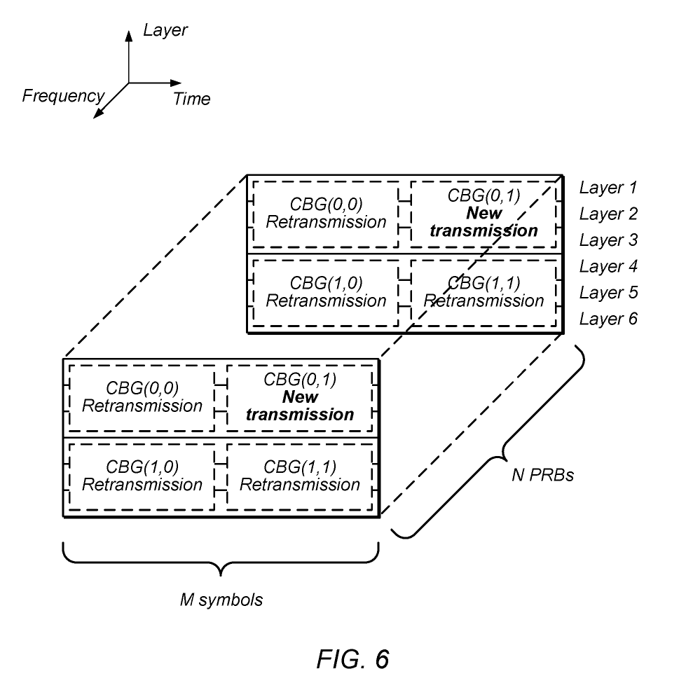

In the illustrated example, CBG(0,1) is successfully decoded by the mobile device and the other CBGs are not, as indicated by the “ACK” and “NAKs.” In some embodiments, the techniques discussed below with reference to FIGS. 6-8 may improve bandwidth for this example situation.

FIG. 5B is a diagram illustrating an exemplary retransmission based on the example transmission in FIG. 5A, according to some embodiments. In this example, the first codeword is used to retransmit CBG(0,0) while the second codeword is used to retransmit CBGs (1,0) and (1,1). Note that CBG(0,0) may be rate matched to a lower coding rate which may reduce throughput for the UE and use resources that the network could have potentially allocated to other UEs. This is an example where the network may not recognize the potential benefit from CBG-based ACK/NAK.

FIG. 6 is a diagram illustrating an exemplary transmission that includes retransmissions and new data, according to some embodiments. In some embodiments, the network is configured to send a new data indicator (e.g., an NDI bit) with each CBG. Said another way, new data indicators may be generated at the CBG granularity in these embodiments. In some embodiments, the indicators may be referred to as CBG transmission indication (CBGTI) that indicates whether the corresponding CBG is a new transmission or a retransmission.

As shown in FIG. 6, this may allow both a retransmission and a new transmission to be sent in the same codeword. FIG. 6 shows an example subsequent transmission following the transmission of FIG. 5A. In this example, the CBGTI for CBG(0,1) indicates that it is a new transmission while the other CBGs are indicated as being retransmissions. This may allow the UE to realize the full bandwidth potential of CBG-based HARQ ACKs, in some embodiments.

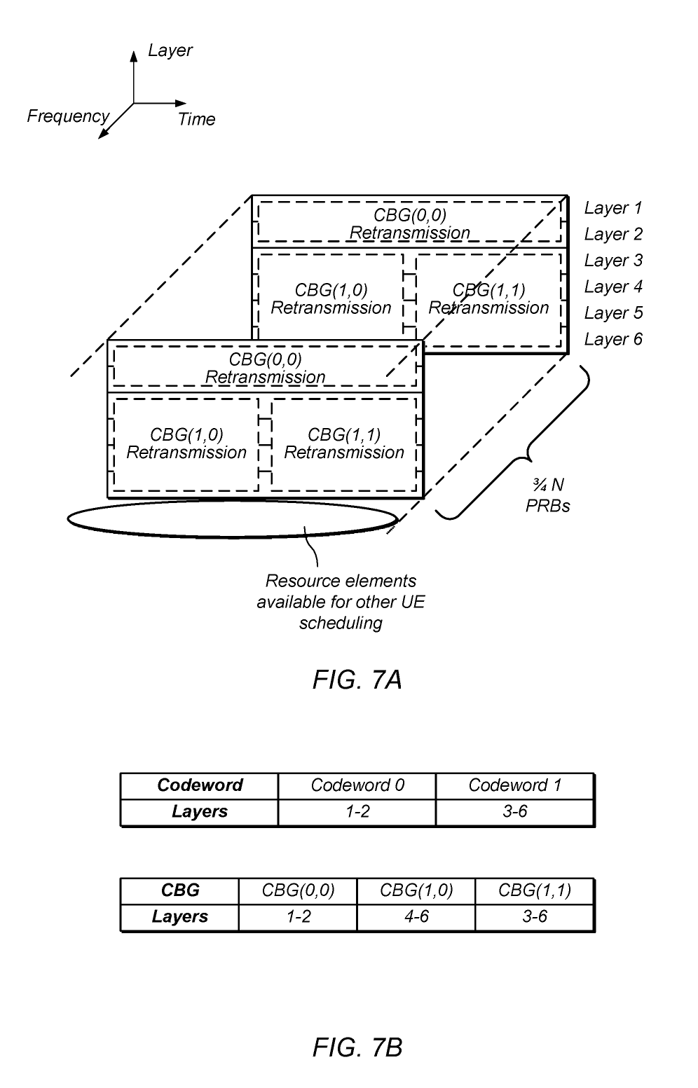

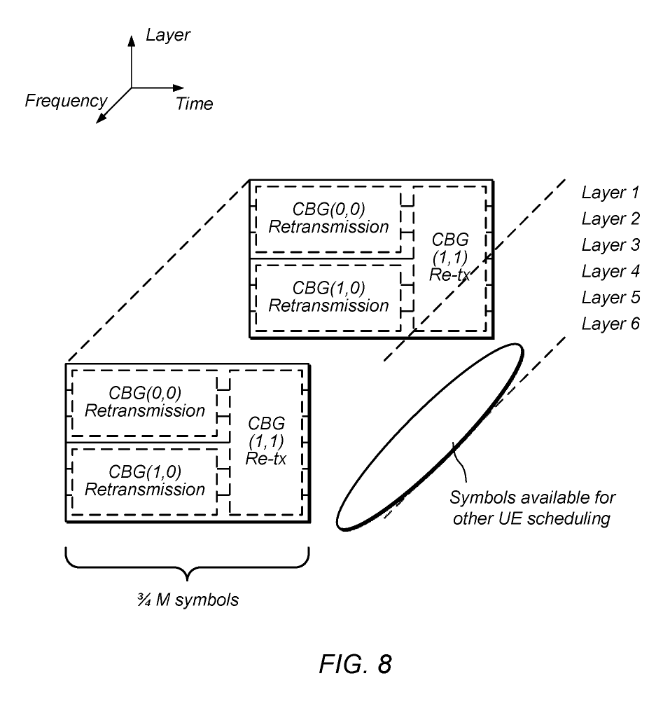

FIG. 7A is a diagram illustrating an exemplary transmission that uses different numbers of layers for a retransmission, according to some embodiments. Speaking generally, the techniques shown with reference to FIGS. 7-8 allow dynamic mapping of codewords and/or CBGs to layers. In some embodiments, this mapping is communicated from the base station to the UE in downlink control information (DCI). In other embodiments, the dynamic mapping may be implicitly signaled. For example, depending on which CBG(s) are successfully received, the number of layers used for other codewords/CBGs may be implied. Similarly to FIG. 6, both FIG. 7A and FIG. 8 show example subsequent transmission following the transmission of FIG. 5A.

In the example of FIG. 7A, CBG(0,0) is retransmitted using a greater number of symbols but a smaller number of layers (2) than the original transmission of this CBG. In the illustrated example, CBGs (1,0) and (1,1) are retransmitted using a greater number of layers (4) than their original transmission. In this illustrated example, this allows the transmission to be performed using a smaller amount of frequency resources relative to the example of FIG. 5B, leaving resource elements available for the network to schedule for other UEs. In this particular example, the retransmission uses ¾ of the PRBs used for the original transmission. This may increase overall network bandwidth in various embodiments.

Note that, in the illustrated example, CBG(0,0) is transmitted in the first codeword and CBG(1,1) is transmitted in the second codeword. In various embodiments, the DCI indicates the layer mapping at codeword granularity, CBG granularity, or both. Thus, in this example, the DCI may indicate that CBG (1,0) and (1,1) are mapped to four layers and/or may indicate that the second codeword is mapped to four layers.

FIG. 7B shows both granularities of mappings discussed above, according to some embodiments. In some embodiments, the mapping information specifies the actual layers for each codeword or CBG. In other embodiments, the mapping information specifies the number of layers for one or more codewords or CBGs and the actual layers and/or information for other codewords/CBGs are implied. For example, the mapping information may simply specify the number of layers N for the first codeword. In this example, and the first codeword may be transmitted using the first N layers with the remaining layers being used for the second codeword. As discussed above, the mappings for either granularity may be implied rather than explicitly communicated between the network and UE. For example, the mapping of codewords and/or CBGs to layers may be specified by a communications standard for possible combinations of successful/unsuccessful CBGs and the base station and UE may determine the mapping without explicitly communicating any mapping information. In other embodiments, the base station and UE may negotiate a set of mappings prior to the example communications.

In the example of FIG. 8, CBG (1,1) is retransmitted using a larger number of layers than the original transmission (all of the layers, in this example). In the illustrated embodiment, the first codeword includes one CBG(0,0) and the second codeword includes CBGs(1,0) and (1,1). This is one example where CBGs in the same codeword may use different numbers of layers, when layer mapping is specified at CBG granularity. In the illustrated example, this allows the transmission to be performed in a smaller amount of time relative to the example of FIG. 5B, leaving symbols available for the network to schedule for other UEs. In this particular example, the retransmission uses ¾ of the symbols used for the original transmission. This may increase overall network bandwidth in various embodiments.

### Example Methods

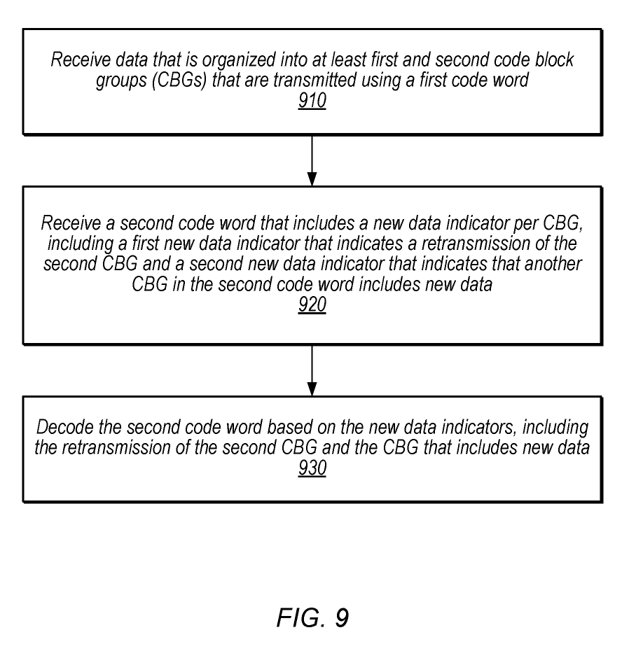

FIG. 9 is a flow diagram illustrating a method for decoding based on new data indicators at CBG granularity, according to some embodiments. The method shown in FIG. 9 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

At 910, in the illustrated embodiment, an apparatus receives data that is organized into at least first and second code block groups (CBGs) that are transmitted using a first code word.

At 920, in the illustrated embodiment, the apparatus receives a second code word that includes a new data indicator per CBG, including a first new data indicator that indicates a retransmission of the second CBG and a second new data indicator that indicates that another CBG in the second code word includes new data.

At 930, in the illustrated embodiment, the apparatus decodes the second code word based on the new data indicators, including the retransmission of the second CBG and the CBG that includes new data.

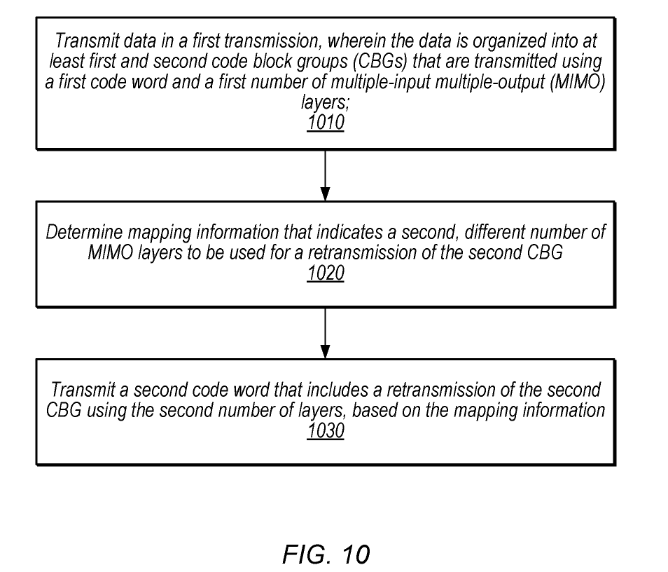

FIG. 10 is a flow diagram illustrating a method for adjusting resources used for retransmissions, according to some embodiments. The method shown in FIG. 10 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

At 1010, in the illustrated embodiment, a base station transmits data in a first transmission, wherein the data is organized into at least first and second code block groups (CBGs) that are transmitted using a first code word and a first number of multiple-input multiple-output (MIMO) layers.

At 1020, in the illustrated embodiment, the base station determines mapping information that indicates a second, different number of MIMO layers to be used for a retransmission of the second CBG. An example of mapping information is discussed above with reference to FIG. 7B. The mapping information may be determined based on the number of retransmissions, for example, or based on the number of overall CBGs in a code word that includes the retransmission of the second CBG. In some embodiments, the base station transmits the mapping information in downlink control information. In other embodiments, a UE may independently determine the mapping information.

The mapping information may be specified at codeword granularity (e.g., specifying a number of MIMO layers for the second codeword) or may be specified at CBG granularity (e.g., specifying a number of MIMO layers for the retransmission of the second CBG).

At 1030, in the illustrated embodiment, the base station transmits a second code word that includes a retransmission of the second CBG using the second number of layers, based on the mapping information. The second number of layers may be smaller than the first number of layers and the retransmission may use a smaller number of resource elements than the first transmission (e.g., as in the example of FIG. 7A. The second number of layers may be greater than the first number of layers and the retransmission may use a smaller number of symbols than the first transmission (e.g., as in the example of FIG. 8).

### Example Computer-Readable Medium

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that is recognized by a fabrication system configured to produce hardware (e.g., an integrated circuit) that includes the disclosed circuitry. Claims to such a storage medium are intended to cover, for example, an entity that produces a circuit design, but does not itself fabricate the design.

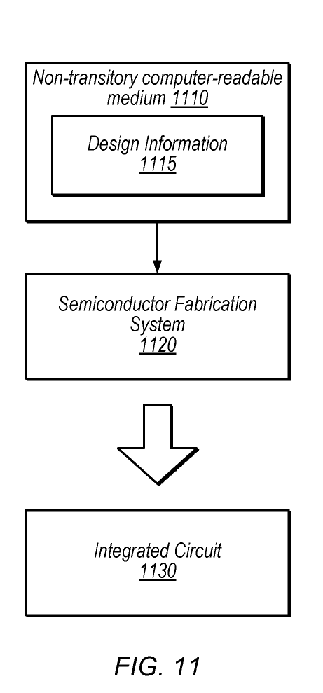

FIG. 11 is a block diagram illustrating an example non-transitory computer-readable storage medium that stores circuit design information, according to some embodiments. In the illustrated embodiment semiconductor fabrication system 1120 is configured to process the design information 1115 stored on non-transitory computer-readable medium 1110 and fabricate integrated circuit 1130 based on the design information 1115.

Non-transitory computer-readable storage medium 1110, may comprise any of various appropriate types of memory devices or storage devices. Non-transitory computer-readable storage medium 1110 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Non-transitory computer-readable storage medium 1110 may include other types of non-transitory memory as well or combinations thereof. Non-transitory computer-readable storage medium 1110 may include two or more memory mediums which may reside in different locations, e.g., in different computer systems that are connected over a network.

Design information 1115 may be specified using any of various appropriate computer languages, including hardware description languages such as, without limitation: VHDL, Verilog, SystemC, SystemVerilog, RHDL, M, MyHDL, etc. Design information 1115 may be usable by semiconductor fabrication system 1120 to fabricate at least a portion of integrated circuit 1130. The format of design information 1115 may be recognized by at least one semiconductor fabrication system 1120. In some embodiments, design information 1115 may also include one or more cell libraries which specify the synthesis and/or layout of integrated circuit 1130. In some embodiments, the design information is specified in whole or in part in the form of a netlist that specifies cell library elements and their connectivity. Design information 1115, taken alone, may or may not include sufficient information for fabrication of a corresponding integrated circuit. For example, design information 1115 may specify the circuit elements to be fabricated but not their physical layout. In this case, design information 1115 may need to be combined with layout information to actually fabricate the specified circuitry.

Integrated circuit 1130 may, in various embodiments, include one or more custom macrocells, such as memories, analog or mixed-signal circuits, and the like. In such cases, design information 1115 may include information related to included macrocells. Such information may include, without limitation, schematics capture database, mask design data, behavioral models, and device or transistor level netlists. As used herein, mask design data may be formatted according to graphic data system (GDSII), or any other suitable format.

Semiconductor fabrication system 1120 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 1120 may also be configured to perform various testing of fabricated circuits for correct operation.

In various embodiments, integrated circuit 1130 is configured to operate according to a circuit design specified by design information 1115, which may include performing any of the functionality described herein. For example, integrated circuit 1130 may include any of various elements shown in FIGS. 1-4. Further, integrated circuit 1130 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present disclosure may be realized in any of various forms. For example some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, an apparatus comprises means for performing one or more of the method elements discussed herein.

In some embodiments, a non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus, comprising:
one or more processors configured to:
receive data in a first transmission, wherein the data is organized into at least first and second code block groups (CBGs) that are transmitted using a first code word and a first number of multiple-input multiple-output (MIMO) layers;
determine mapping information that indicates a second, different number of MIMO layers to be used for a retransmission of the second CBG; and
receive and decode a second code word that includes a retransmission of the second CBG using the second number of layers, based on the mapping information.

2. The apparatus, of claim 1, wherein the one or more processors are further configured to transmit control data, prior to receiving the second code word, indicating successful reception of the first CBG and failure to receive the second CBG.

3. The apparatus of claim 1, wherein the apparatus is configured to determine the second number of MIMO layers based on successful reception of the first CBG and failure to decode the second CBG.

4. The apparatus of claim 1, wherein the determined mapping information is received from a cellular network element in downlink control information.

5. The apparatus of claim 1, wherein the second number of layers is smaller than the first number of layers and the retransmission uses a smaller number of resource elements than the first transmission.

6. The apparatus of claim 1, wherein the second number of layers is greater than the first number of layers and the retransmission uses a smaller number of symbols than the first transmission.

7. The apparatus of claim 1, wherein the mapping information is determined at code word granularity specifies a number of MIMO layers for the second code word.

8. The apparatus of claim 1, wherein the mapping information is determined at CBG granularity and specifies a number of MIMO layers for the retransmission of the second CBG.

9. A method, comprising:
transmitting data in a first transmission, wherein the data is organized into at least first and second code block groups (CBGs) that are transmitted using a first code word and a first number of multiple-input multiple-output (MIMO) layers;
determine mapping information that indicates a second, different number of MIMO layers to be used for a retransmission of the second CBG; and
transmitting a second code word that includes a retransmission of the second CBG using the second number of layers, based on the mapping information.

10. The method of claim 9, further comprising:
determining the second number of MIMO layers based on a number of retransmitted CBGs.

11. The method of claim 9, further comprising transmitting the mapping information in downlink control information.

12. The method of claim 9, wherein the second number of layers is smaller than the first number of layers and the retransmission uses a smaller number of resource elements than the first transmission.

13. The method of claim 9, wherein the second number of layers is greater than the first number of layers and the retransmission uses a smaller number of symbols than the first transmission.

14. The method of claim 9, wherein the mapping information specifies a number of MIMO layers for the second code word.

15. The method of claim 9, wherein the mapping information specifies a number of MIMO layers for the retransmission of the second CBG.

16. A non-transitory computer-readable medium having instructions stored thereon that are executable by a computing device to perform operations comprising:
receiving data in a first transmission, wherein the data is organized into at least first and second code block groups (CBGs) that are transmitted using a first code word and a first number of multiple-input multiple-output (MIMO) layers;
determining mapping information that indicates a second, different number of MIMO layers to be used for a retransmission of the second CBG; and
receiving and decoding a second code word that includes a retransmission of the second CBG using the second number of layers, based on the mapping information.

17. The non-transitory computer-readable medium of claim 16, wherein the operations further comprise:
transmitting control data, prior to receiving the second code word, indicating successful reception of the first CBG and failure to receive the second CBG.

18. The non-transitory computer-readable medium of claim 16, wherein the operations further comprise:
determine the second number of MIMO layers based on successful reception of the first CBG and failure to decode the second CBG.

19. The non-transitory computer-readable medium of claim 16, wherein the second number of layers is smaller than the first number of layers and the retransmission uses a smaller number of resource elements than the first transmission.

20. The non-transitory computer-readable medium of claim 16, wherein the second number of layers is greater than the first number of layers and the retransmission uses a smaller number of symbols than the first transmission.
